(19) United States
(12) Patent Application Publication
(10) Pub. No.: US 2025/0354644 A1
(43) Pub. Date: Nov. 20, 2025

(54) SCREWED CLAMP WITH LOCALIZED STRUCTURAL REINFORCEMENT PRODUCED BY ADDITIVE MANUFACTURING AND THE PROCESS OF OBTAINING THE CLAMP

(71) Applicants: Petróleo Brasileiro S.A. – Petrobras, Rio de Janeiro (BR); Universidade Federal de Santa Catarina — UFSC, Florianópolis (BR)

(72) Inventors: Giovani DALPIAZ, Canoas (BR); Daniel GALEAZZI, Florianópolis (BR); Mateus Barancelli SCHWEDERSKY, Florianópolis (BR); Eduardo Alberto FANCELLO, Florianópolis (BR); Marcelo Torres Piza PAES, Rio de Janeiro (BR); Ricardo Reppold MARINHO, Rio de Janeiro (BR); Fabio DE CASTRO MARANGONE, Rio de Janeiro (BR); Maxmilian MAINARDI, Guarulhos (BR); Régis Henrique GONÇALVES E SILVA, Florianópolis (BR); Laercio Meneses SILVA JUNIOR, Florianópolis (BR); Claudio Marques SCHAEFFER, Florianópolis (BR); Paulo De Tarso ROCHA DE MENDONÇA, Florianópolis (BR); Cleber MARQUES, Florianópolis (BR); Francisco Francelino Ramos NETO, Rio de Janeiro (BR); José Carlos DE CARVALHO PEREIRA, Florianópolis (BR)

(21) Appl. No.: 19/208,314

(22) Filed: May 14, 2025

(30) Foreign Application Priority Data
May 20, 2024 (BR) 1020240099613

(51) Int. Cl. F16L 55/18; F16L 23/036

(52) U.S. Cl. CPC F16L 55/18; F16L 23/036

(57) ABSTRACT

A screwed bipartite clamp comprising an automated addition by a robotic arm of metallic material to the outer wall of the screwed clamp with a cover by means of additive manufacturing via an electric arc welding process, only in the regions of greatest structural weakness, eliminating the need for the entire wall to be thick, and making it lighter than traditional clamps. Said bipartite clamps manufactured by a process comprising the following steps: (1) execution of machining and forming operations of the flat sheet at a supplier; (2) welding of the cover onto one of the shells; (3) welding of the flanges onto the shells; (4) automated execution by a robotic arm of the additive manufacturing via an electric arc welding process on the sealing channels; (5) automated execution by a robotic arm of the additive manufacturing via an electric arc welding process on the shell close to the flanges.

### CROSS-REFERENCE TO RELATED APPLICATIONS

This application claims priority to Brazilian patent application Ser. No. 1020240099613, filed May 20, 2024, which is incorporated herein in its entirety by reference thereto.

### FIELD OF THE INVENTION

The present invention is part of the technical field of oil and gas, specifically related to pipeline repair operations in oil fields, with the purpose of stopping leaks using mechanical sealing elements and relates to a screwed clamp with localized structural reinforcement, produced by additive manufacturing, and the process for obtaining said clamp.

### BACKGROUND OF THE INVENTION

Pipeline repair operations in oil fields require speed and agility from operators to stop the leak in order to avoid major damage to the environment, as well as to avoid interruption in the supply of the product to the customers of the concessionaires. In view of this fact, it is considered that the lighter the repair elements, the faster this repair operation will be.

Among the several types of pipeline repairs, there is the screwed bipartite clamp. The clamps currently used have a very low diameter/thickness ratio (large thickness when compared to the diameter), since they do not comply with a relevant characteristic of pipeline repair operations, which consists of their speed of execution. This fact makes these clamps very heavy and difficult to handle in the field.

Particularly in Brazil, pipeline damage occurs very frequently due to thefts, which are carried out from the installation of clandestine bypasses. At the end of these occurrences, the clandestine bypasses are abandoned without, obviously, any attention to the safety of the line.

For these situations, a repair element called a cover must be incorporated into pipeline repair operations. This classification of pipeline damage in Brazil and the need for immediate repair means that the combination of a bipartite clamp and cover is used in a very advantageous way.

The screwed clamp is not yet considered a permanent repair by operators, unless it is fully welded. Sealing elements must be incorporated into it, which are accommodated in channels in its wall.

The two particularities of screwed clamps with a cover are: a) channels for sealing and b) flanges to accommodate the screws. This means that this type of repair requires high wall thickness, and, as a consequence, it is difficult to handle during repair operations.

In summary, as previously mentioned, screwed clamps with a cover, with a wall thickness greater than the thickness of the ducts on which they are installed, are quite robust and heavy and, consequently, difficult to handle during duct repair operations, incurring longer installation time and more expensive logistics (transportation and storage).

Thus, the present invention allows reducing the average thickness of the clamp shell and, therefore, its mass, and in order to solve the technical problems previously reported, the present invention proposes a screwed clamp with localized structural reinforcement produced by additive manufacturing, as well as the manufacturing process of this clamp.

The use of the manufacturing process called additive manufacturing, via electric arc welding processes, automatically adds, by robotic arm, metallic material (preferably carbon steel) to the shell of the screwed clamps with a cover only in the regions of greatest structural weakness, namely: in the regions close to the channels and flanges.

This allows reducing the total thickness of the wall and, consequently, reduces the weight of the screwed clamp with a cover, thus facilitating its handling during repair operations.

### State of the Art

Some documents were identified that describe clamps similar to those of the present invention. One of these convergences is in the final objective shared by these inventions: to contain leaks in pipelines (although it does not apply to document CN 112140527). However, it is important to emphasize that, apart from these common points, the characteristics differ considerably.

The document CN 112140527 is part of the general state of the art and describes a method for 3D printing (a technique that falls within the field of additive manufacturing) of an internal reinforcement structure in a splice display sample. When compared with the present invention, differences are noted, since the additive manufacturing technique used is similar to that called Powder Bed Fusion (PBF) and the technical problem to be solved (reduction of the mass of the part) differs from the object of the application in question.

In addition, it is noted that said document uses a printer to manufacture components and is limited to their size, while the present invention uses a robotic arm, which has greater freedom to produce large components, as is the case of parts for the oil and gas sector.

In its turn, the document US 20200149672 is also part of the general state of the art and proposes a clamp for repairing pipes that includes a clamp body that defines a central opening in which a pipe is received. The gaskets are located inside the clamp body that seals the pipe on both sides of the leak and are provided with fiber armor reinforcement to prevent extrusion of the gaskets. It should be noted that this document is more focused on the sealing aspects when the pipeline leaks than particularly on the repair itself and makes no mention of the additive manufacturing process.

The document CN 212537019 is a utility model that refers to the field of stainless steel pipe connection and discloses a stainless steel pipe sealing connection structure that rotates through the screw rod and is located in the internal rotation of the screw. It should be noted that this document is also more focused on the sealing aspects when the pipeline leaks than particularly on the repair itself and makes no mention of the additive manufacturing process.

Finally, the document BR 112018003615, which is also part of the general state of the art, describes a conduit connection system with a clamp that can be manufactured using conventional techniques, such as, for example, stamping, casting, machining or molding and, alternatively, can be manufactured using techniques such as additive manufacturing or additive production. Comparing with the present invention, it is noted that the application, location, structural characteristics, materials and functionalities expected from additive manufacturing for said document and for the proposed invention are also different.

Thus, considering the above, it is possible to perceive relevant differences in the solutions from the state of the art in relation to the present invention and it is also possible to verify the presence of a differential technical effect in the present invention, considering not only the intrinsic advantages of the clamp and its production process, but also differences in the focus of application, since some of the documents are more focused on the aspects of sealing when the pipeline leaks than particularly on the repair itself.

It is important to highlight that the present invention offers advantages in productivity and speed, since the repair with the proposed clamp allows for more agile and, consequently, faster handling. There will also be an advantage in the cost and speed of the process of manufacturing and supplying the clamps.

The use of thinner sheets for the shells results in less material used (thinner sheets are cheaper than thicker sheets) and greater ease of calendering (curving flat sheets to form the shells), reducing the cost of calendering and promoting a greater number of calendering suppliers, since few companies have equipment large enough to calender larger sheets).

As a result of the operational advantage, there will be an economic advantage, due to the reduction in the total time of the operation. There will also be a logistical advantage, since transportation and storage operations are increasingly expensive and restricted, in terms of the weight of the products transported.

### BRIEF DESCRIPTION OF THE INVENTION

The present invention relates to a screwed bipartite clamp that comprises an automated addition, by a robotic arm, of metallic material to the outer wall of the screwed clamp with a cover, by means of additive manufacturing via an electric arc welding process, only in the regions of greatest structural weakness, eliminating the need for the entire wall to be thick, and making it lighter than traditional clamps. Said clamps are preferably manufactured by a process that essentially comprises the following steps: (1) execution of the machining and forming operations of the flat sheet at the supplier; (2) welding of the cover onto one of the shells; (3) welding of the flanges onto the shells; (4) automated execution by a robotic arm of the additive manufacturing, via an electric arc welding process on the sealing channels; (5) automated execution by robotic arm of additive manufacturing, via electric arc welding process on the shell close to the flanges.

### BRIEF DESCRIPTION OF THE FIGURES

In order to obtain a complete and total view of the object of this invention, the figures to which references are made below are indicated.

FIG. 1 schematically represents an example of a perforated duct section with a bypass.

FIG. 2 shows a cross-sectional view of how a screwed clamp is installed on a perforated duct with a bypass.

FIG. 3 schematically represents how a traditional clamp, without additive manufacturing (MA) reinforcements, is installed on a duct.

FIG. 4 schematically represents a clamp without additive manufacturing (MA) reinforcements, highlighting the fact that it is bipartite and has a greater thickness.

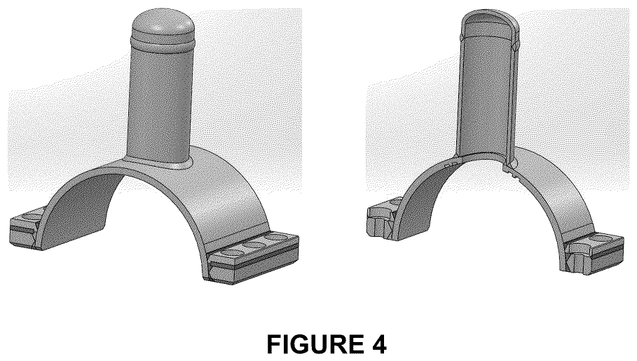

FIG. 5 schematically represents how a clamp with additive manufacturing (MA) reinforcements, which is the object of the present invention, is installed on a duct.

FIG. 6 represents a clamp with additive manufacturing (MA) reinforcements, highlighting the fact that it is bipartite and has a smaller thickness.

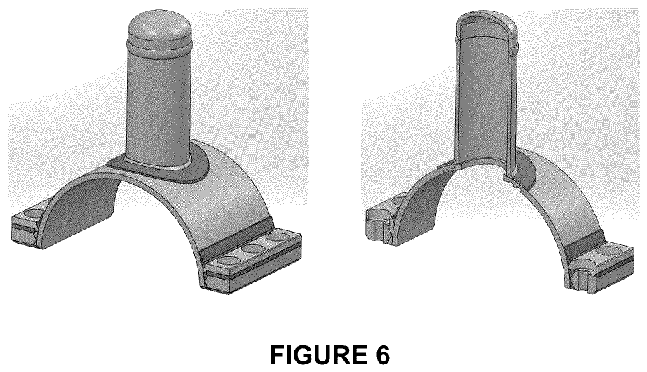

FIG. 7 schematically represents the flowchart of the process for obtaining a clamp as described in the present invention.

### DETAILED DESCRIPTION OF THE INVENTION

The present invention relates to a screwed bipartite clamp that comprises an automated addition by a robotic arm of metallic material by means of additive manufacturing, via an electric arc welding process, on the external wall of the screwed clamp with a cover, only in the regions of greatest structural weakness (on the sealing channels and at the interface between the half-shells and the flanges), eliminating the need for the entire wall to be thick, making it lighter than traditional clamps. The process is automated, with control of the welding energy and material feed.

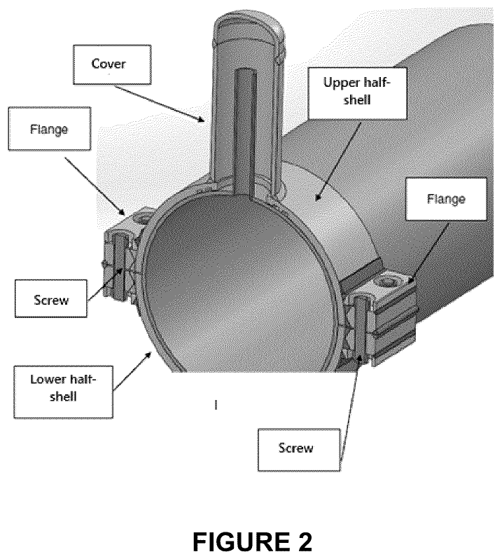

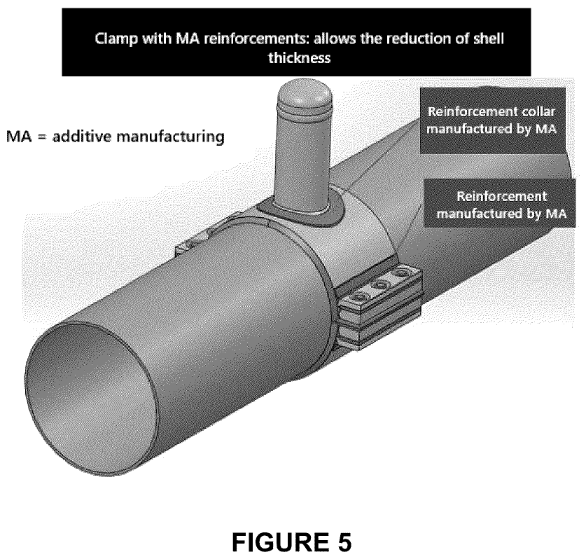

As shown in FIGS. 2 and 5, the clamp comprises two main parts, an upper half-shell with a cover and a lower half-shell, which are circular in shape to fit over the duct to be repaired. Each half-shell has flanges on both sides with at least three holes so that the screws can be inserted after the clamp has been installed on the ducts.

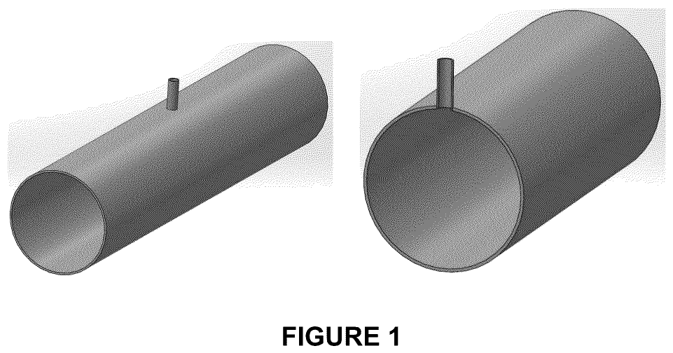

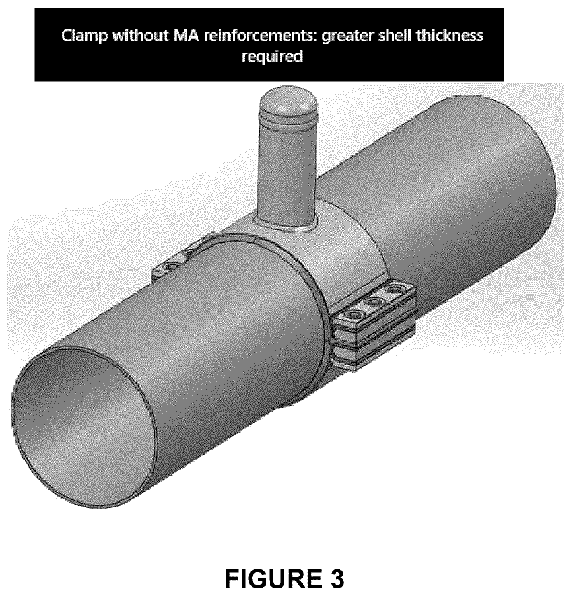

The upper half-shell comprises the cover so that it can wrap (encapsulate) the perforated duct with a bypass (shown in FIGS. 1 and 2), where FIG. 2 shows a cross-section of the clamp for better viewing of the internal parts and FIG. 3 shows the complete clamp installed and in operation.

The lower half-shell does not comprise the cover and has the function of joining the clamp around the duct and serving as support for the assembly as a whole.

As shown in FIG. 5, the clamp is reinforced at the base of the cover forming a reinforcement collar, and is additionally reinforced at the interface of the half-shells with the flanges.

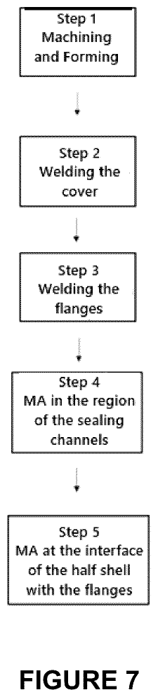

As shown in FIG. 7, said clamps are preferably manufactured by a process that essentially comprises the following steps:
(1) execution of the machining and forming operations of the flat sheet at the supplier using traditional manufacturing processes;
(2) welding of the cover onto the upper half-shell;
(3) welding of the flanges onto the half-shells;
(4) automated execution by a robotic arm of the manufacturing via an electric arc welding process on the sealing channels (operation performed by an engineer with expertise in additive manufacturing);
(5) automated execution by a robotic arm of the additive manufacturing via an electric arc welding process at the interface of the half-shell with the flanges (operation also performed by an engineer with expertise in additive manufacturing).

There are also the following pre-steps that are performed before executing the process described above:
(1.1) study to obtain the highest diameter/thickness ratio of the half shells, which will provide a lighter product that will facilitate field operations (this study will facilitate the machining and shaping operations of the shells, allowing this process to be performed by a greater number of suppliers of this service);
(1.2) study to obtain the number of MA welding passes on the region of the sealing channels (region that will require reinforcement);
(1.3) study to obtain the number of MA welding passes and their extension at the interface of the half shells with the flanges (region that will require reinforcement).

More specifically, these two studies are carried out using the following methodology: 1) obtaining the total dimension (width and thickness) of the reinforcement to be deposited by additive manufacturing (MA); 2) parameterization of the MA process by electric arc welding and measurement of the geometry of the weld beads and individual layers; and 3) programming the trajectory of the MA process by electric arc welding, in order to obtain the total dimension of the reinforcement (first step above).

In short, the present technology shows a clamp reinforced at previously determined points, specifically, along the region of the sealing channel(s) and parallel to the flanges, with automated addition by a robotic arm of metallic material (preferably carbon steel) by additive manufacturing, via the electric arc welding process, without the need to promote an increase in the thickness of the entire part.

It is not possible to measure a reduction in thickness, since the thickness is intrinsically related to the class of the duct (operating pressure) and the diameter of the duct. The proposal of this invention encompasses any class and any diameter of duct.

Those skilled in the art will value the knowledge being shown and will be able to reproduce the invention in the indicated embodiments and in other variants, covered by the scope of the attached claims.

1. A screwed clamp with localized structural reinforcement, wherein the clamp is bipartite and comprises:
an upper part or upper half-shell; and
a lower part or lower half-shell,
wherein the upper part or upper half-shell and the lower part or lower half-shell are circular in shape and comprise flanges on both sides,
wherein the flanges have at least three perforations so that fastening screws can be inserted,
wherein the upper part or upper half-shell comprises a cover configured to enclose a perforated duct with a bypass.

2. The clamp according to claim 1, wherein an external wall of the clamp is reinforced with an automated addition, by a robotic arm, of metallic material through additive manufacturing.

3. The clamp according to claim 1, wherein the lower part or lower half-shell is configured to join the clamp around the duct and serve as support for the assembly as a whole.

4. The clamp according to claim 1, wherein the clamp is reinforced in a region of the cover to form a reinforcement collar, and is additionally reinforced at an interface between the parts or half-shells and the flanges.

5. A process for obtaining a clamp, the process comprising the steps of:
machining and forming a flat sheet into a first half shell and a second half shell;
welding a cover onto one of the first or second half shells;
welding flanges onto the first and second half shells;
automatically executing, by a robotic arm, additive manufacturing via an electric arc welding process on sealing channels; and
automatically executing, by the robotic arm, additive manufacturing via an electric arc welding process at an interface of the half shells and the flanges.

6. The process according to claim 5, further comprising:
studying to obtain a diameter/thickness ratio of the half shells;
studying to obtain a number of welding passes on a region of the sealing channels by the additive manufacturing; and
studying to obtain the number of welding passes by the additive manufacturing and their extension at the interface of the half shells and the flanges.
